(19) United States
(12) Patent Application Publication
(10) Pub. No.: US 2006/0077350 A1
(43) Pub. Date: Apr. 13, 2006

(54) 3-Panel transmissive projection system

(76) Inventor: Adrianus Johannes Stephanes Maria De Vaan, Eindhoven (NL)

Correspondence Address: PHILIPS INTELLECTUAL PROPERTY & STANDARDS, P.O. BOX 3001, BRIARCLIFF MANOR, NY, 10510, US

(21) Appl. No.: 10/530,381

(22) PCT Filed: Sep. 18, 2003
(86) PCT No.: PCT/IB03/04164

§ 371 Date: Apr. 6, 2005

(30) Foreign Application Priority Data
Oct. 9, 2002 (EP) 02079175.2

(51) Int. Cl. G02F 1/1335

(52) U.S. Cl. 353/20; 349/9

(57) ABSTRACT

The invention relates to a 3-panel transmissive projection system. In particular, the invention relates to a 3-panel transmissive projection system applying reflective type polarizers for both polarizing and analyzing operations in the projection system.

### FIELD OF THE INVENTION

The invention relates to a 3-panel transmissive projection system. In particular, the invention relates to a 3-panel transmissive projection system applying reflective type polarizers for both polarizing and analyzing operations in the projection system.

### BACKGROUND OF THE INVENTION

Projection systems, such as described in, for example, US patent application no. 2002/0015135, generally use a reflective LCD array with a single polarizing beam splitter. However, by combining the light path from the light source and the display panels with the light path between the display panels and the projection lens, the light paths cannot be optimized individually.

The high-temperature (HT) polyfilm technology provides high brightness using small miniaturized LCD panels. However, the combination of miniaturisation and high light output causes extreme high light densities in the light path, thus limiting the lifetime expectancy of the LCD panels and polarizing films. The manufacturers of HT polyfilm projection systems continuously improve the lifetime expectancy of the LCD panels. However, improvements in the lifetime expectancy of the polarizing films has almost come to a halt. Hence, the lifetime expectancy of the HT polyfilm projection system is limited by the lifetime of the polarizing films.

### OBJECT AND SUMMARY OF THE INVENTION

It is an object of the present invention to provide a projection system having high brightness capabilities in combination with an improved lifetime expectancy.

It is a further object of the present invention to provide a transmissive type projection system, such as transmissive HT Poly silicon LCDSs, so as to ensure that the light path between the light source and the display panel(s) and the light path between the display panel(s) and the projection lens are completely separated, and therefore may be optimized individually, leading to a higher system efficiency and to a higher brightness.

A particular advantage of the present invention is the provision of a low-cost projection system having a high brightness and a long lifetime expectancy by using miniaturized transmissive display panels.

A particular feature of the present invention relates to the provision of polarizers for the analyzing operation and for the polarization operation of the projection system.

According to a first aspect of the present invention, this object is achieved by a projection system for projecting an image onto a projection surface, the projection system comprising:
(a) a light source for supplying light;
(b) an optical element for gathering and focusing said light, thereby providing a light beam;
(c) a first reflective polarizer for polarizing said light beam, thereby generating a polarized light beam;
characterized in that the projection system further comprises:
(d) a transmissive display panel for receiving said polarized light beam and for manipulating said polarized light beam, thereby encoding image information on said polarized light beam and generating an encoded light beam;
(e) means for controlling each pixel of said transmissive display panel so as to control manipulation of said polarized light beam; and
(f) a second reflective polarizer for rejecting unwanted polarizations of said encoded light beam and for transmitting desired polarization of said encoded light beam to said projection surface.

In this context, the term image is to be construed as a frame of a video sequence, a still photograph or a still digital representation or any combination thereof

The second reflective polarizer according to the first aspect of the present invention may be oriented with respect to the encoded light beam at incident angles in the range between approximately 30° and 60°, such as incident angles of 35°, 45° or 55°. By orienting the second reflective polarizer acting as an analyzer at an angle of approximately 45°, ghost images generated by light bounced back from the second reflective polarizer to the display panel are avoided.

The projection system according to the present invention may be realised by folding the light path from the light source to the projection surface in a two-layer structure. By folding the light path, the projection system advantageously provides a very compact projection system.

The transmissive display panel may comprise an electro-optical medium such as liquid crystal or plasma, or electrochromic or electrophoretic elements, light-emitting elements, organic or inorganic light-emitting elements, polymer light-emitting elements, or any combination thereof. Any type of display element may be used for the transmissive display panel as long as the display substrates are transparent or opaque. The flexibility of a transmissive display panel type provides a projection system which may be designed in accordance with a wide variety of customer requirements or specifications.

The means for controlling each pixel of the transmissive display panel according to the first aspect of the present invention may be implemented by using any processor techniques known to persons skilled in the art. The means for controlling each pixel may be incorporated on the transmissive display panel substrate, thereby reducing the required space and optimizing the production costs.

The second reflective polarizer may comprise a Moxtek™ beam splitter. By utilising a Moxtek™ beam splitter for the analyzing operation of the projection system, an excellent brightness, low cost, and long lifetime expectancy are obtained. The Moxtek™ beam splitter removes the disadvantages of the polarizer films.

### BRIEF DESCRIPTION OF THE DRAWINGS

The above, as well as additional objects, features and advantages of the present invention, will be better understood from the following illustrative and non-limiting detailed description of preferred embodiments of the present invention, with reference to the appended drawings, wherein:

FIG. 1 is a schematic diagram of the elements and light path for one colour in the preferred embodiment of the present invention; and

FIG. 2 is a detailed diagram of the elements and light paths for red, green and blue colours, shown unfolded for the sake of simplicity, of the preferred embodiment of the present invention.

### DETAILED DESCRIPTION OF PREFERRED EMBODIMENTS

In the following description of various embodiments, reference is made to the accompanying Figures which form a part thereof, and in which various embodiments in which the invention may be practised are shown by way of illustration. It is to be understood that other embodiments may be utilized, and structural and functional modifications may be made without departing from the scope of the present invention.

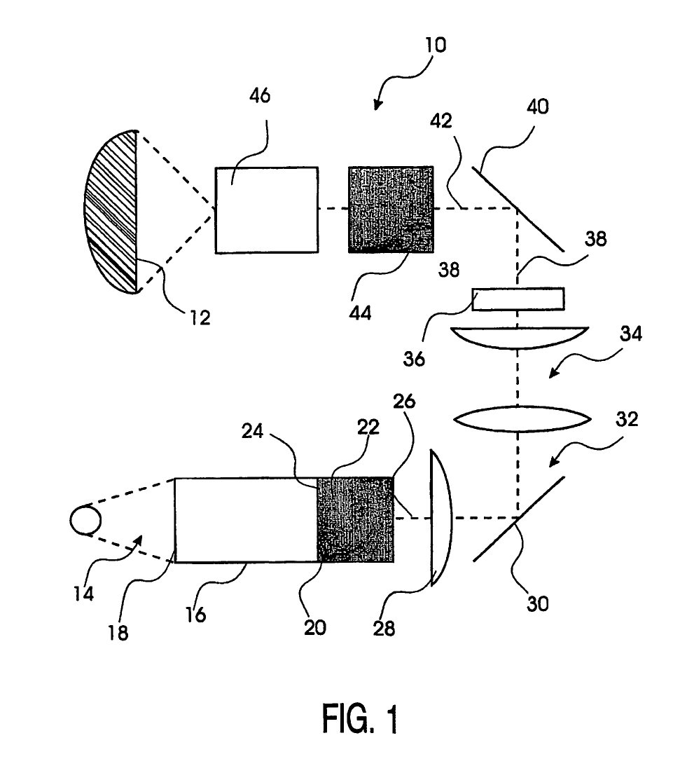

FIG. 1 shows a projection system, designated in its entirety by reference numeral 10, for projecting images onto a projection surface 12. The projection system 10 comprises a light source 14 supplying the light to be transmitted through the projection system 10. The projection surface 12 may be formed on any type of surface such as a white wall or a projector screen.

The light source 14 supplies light to an optical element 16 for gathering and focusing the light, thereby providing a light beam. The optical element 16 may be implemented by a rod integrator. The optical element 16 comprises a first end 18 for receiving the light and a second end 20 for providing the gathered and focused light. A small colour separation prism 22 is placed adjacent to the second end 20. An entrance surface 24 of the colour separation prism 22 is substantially equal to the surface of the second end 20. The colour separation prism 22 separates the light into red, blue and green coloured light, respectively, which is subsequently reflected onto separate exit planes of the colour separation prism 22. For reasons of simplicity, FIG. 1 shows only one light path for one colour.

The coloured light 26 exiting the colour separation prism 22 is directed through a first lens 28 focusing the coloured light 26 onto a first polarizer 30 which is transmissive to unwanted polarizations of coloured light and reflective to desired polarizations, i.e. reflecting a polarized light beam 32. In an alternative embodiment of the present invention, the first polarizer 30 may be reflective to unwanted polarizations of coloured light and transmissive to desired polarizations. This, however, obviously requires a change of the design and the light path from the light source to the projection surface.

In addition, the first polarizer 30 may be reflective to both desired and undesired polarizations of the coloured light. The desired polarizations of the coloured light are directed in one direction and the undesired polarizations are directed in another direction.

The polarized light beam 32 is focused through a second and third lens 34 communicating the polarized light beam to a transmissive display panel 36 which modulates the polarized light beam so as to encode image information thereon. The transmissive display 36 panel is controlled by a processor controlling each pixel of the transmissive display panel 36.

The transmissive display panel 36 may be implemented in a number of ways. By way of example, a transmissive display panel having an opaque substrate may utilise an electro-optical medium such as liquid crystal or plasma, or electrochromic or electrophoretic elements, light-emitting elements, organic or inorganic light-emitting elements, polymer light-emitting elements, or any combination thereof

In the preferred embodiment of the present invention, the transmissive display panel 36 utilises a liquid crystal display array.

As described above, the colour separation prism 22 is placed adjacent to the optical element 16 so as to form an extension on the optical element 16. Hence, the colour separation prism may be made very small. This, however, necessitates the coloured light to be expanded in cross-sectional area so as to match the transmissive display panel 36. The expansion of the coloured light is performed by the second lens 34.

FIG. 1 shows a single transmissive display panel 36 for simplicity only. It is to be understood that each coloured light separated by the colour separation prism 22 is communicated to a specific transmissive display panel.

The transmissive display panel generates an encoded light beam 38, which is communicated to a second polarizer 40 operating as an analyzer rejecting unwanted polarizations of the encoded light beam from the light path.

The second polarizer 40 is transmissive to unwanted polarizations of the encoded light beam and reflective to desired polarizations of the encoded light beam. In an alternative embodiment of the present invention, the second polarizer may be reflective to unwanted polarizations of coloured light and transmissive to desired polarizations. This, however, obviously requires a change of the design and the light path from the light source to the projection surface.

As described with reference to the first polarizer 30, the second polarizer 40 may be reflective to both desired and undesired polarizations of the encoded light beam. The desired polarizations of the encoded light beam are directed in one direction and the undesired polarizations are directed in another direction.

In the preferred embodiment of the present invention, the first and second polarizers 30, 40 may be implemented by a Moxtek™ beam splitter. However, the first and second reflective polarizers 30, 40 may be implemented by a wide variety of polarizers such as wire-grid polarizers, cholesteric polarizers, interference films, holographic structures, stacks of thin birefringent films, beam splitters, mirrors, or any combination thereof.

The polarized and encoded light 42 is received in a recombination prism 44 gathering each polarized and encoded light beam from each coloured light path, i.e. the red, green and blue light paths. The recombined light forms a complete image to be projected through a projection lens 46 onto the projection surface 12.

The two prisms 22 and 44 may be implemented in a wide variety of ways. However, in the preferred embodiment of the present invention, the prisms 22 and 44 are implemented by a first and a second dichroic cube.

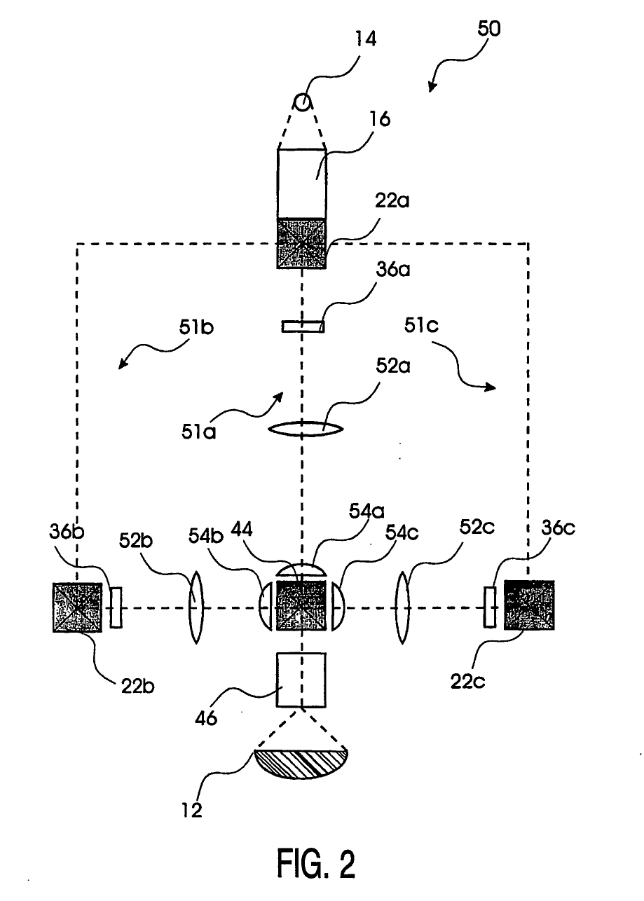

FIG. 2 shows a projection system designated in its entirety by reference numeral 50. In contrast to FIG. 1, FIG. 2 shows three light paths: a red light path 51a, a green light path 51b, and a blue light path 51c.

Elements of the projection system 10 described with reference to FIG. 1, which are identical to elements in FIG. 2, are denoted by the same reference numerals.

The light source 14 supplies the light of the projection system 50, and the optical element 16 focuses and gathers the light from the light source 14 prior to directing the light to a colour separation prism 22. The colour separation prism is shown in FIG. 2 as prisms denoted by reference numerals 22a, 22b and 22c. The prism 22a provides the red light through the red light path 51a to a first transmissive display panel 36a. The prism 22b provides the green light through the green light path 51b to a second transmissive display panel 36b. The prism 22c provides the blue light through the blue light path 51a to a third transmissive display panel 36c.

Each transmissive display panel 36a, 36b and 36c modulates the light in accordance with the generation of particular images. The transmissive display panels 36a, 36b and 36c are controlled by one or more processors controlling each pixel of the transmissive display panels 36a, 36b and 36c.

The encoded lights: encoded red, encoded green, and encoded blue are enhanced through sets of lenses 52a, 52b, 52c and 54a, 54b and 54c. The sets of lenses allow the use of a very small dichroic cube for the colour recombination prism 44.

As described with reference to FIG. 1, the light now recombined is projected on the projection surface through a projection lens 46.

The projection system 50 may be folded into a two-layer configuration using polarizers for the polarizing and analyzing operation, similarly as described with reference to FIG. 1.

1. A projection system for projecting an image onto a projection surface (12), the projection system comprising:
(a) a light source (14) for supplying light;
(b) an optical element (16) for gathering and focusing said light, thereby providing a light beam (26);
(c) a first reflective polarizer (30) for polarizing said light beam (26), thereby generating a polarized light beam (32);
characterized in that the projection system further comprises:
(d) a transmissive display panel (36) for receiving said polarized light beam (32) and for manipulating said polarized light beam (32), thereby encoding image information on said polarized light beam and generating an encoded light beam (38);
(e) means for controlling each pixel of said transmissive display panel so as to control manipulation of said polarized light beam (38); and
(f) a second reflective polarizer (40) for rejecting unwanted polarizations of said encoded light beam (38) and for transmitting desired polarization of said encoded light beam (38) to said projection surface (12).

2. A projection system as claimed in claim 1, wherein said first and second reflective polarizers comprise wire-grid polarizers, cholesteric polarizers, interference films, holographic structures, stacks of thin birefringent films, beam splitters, mirrors, or any combination thereof.

3. A projection system as claimed in claim 1, wherein said second reflective polarizer (40) is oriented with respect to said encoded light beam at incident angles in the range between approximately 30°and 60°, such as incident angles of 35°, 45° or 55°.

4. A projection system as claimed in claim 1, wherein said projection system is realised by folding the light path from said light source (14) to the projection surface (12) in a two-layer structure.

5. A projection system as claimed in claim 1, wherein said transmissive display panel (36) comprises an electro-optical medium such as liquid crystal or plasma, or electrochromic or electrophoretic elements, light-emitting elements, organic or inorganic light-emitting elements, polymer light-emitting elements, or any combination thereof.

6. A projection system as claimed in claim 1, wherein said means for controlling each pixel of said transmissive display panel (36) is implemented by using a processor.

7. A projection system as claimed in claim 1, wherein said means for controlling each pixel may be incorporated on said transmissive display panel substrate.

8. A projection system as claimed in claim 1, further comprising an optical element (16) for gathering said light from said light source (14) and having an exit surface (20) adjacent to a colour separation prism (22) having an entrance surface (24) which is substantially equal to said exit surface (20).

9. A projection system as claimed in claim 8, wherein said colour separation prism (22) is adapted to separate said light supplied by said light source (14) into red, green and blue coloured light.

10. A projection system as claimed in claim 1, wherein said transmissive display panel (36) comprises a first (36a), second (36b) and third (36c) transmissive display panel unit, respectively.

11. A projection system as claimed in claim 8, wherein said colour separation prism (22) is adapted to communicate red, green and blue coloured light to said first (36a), second (36b) and third (36c) transmissive display panel units.

12. A projection system as claimed in claim 1, further comprising a recombination prism (44) for recombining encoded light beams into a single encoded light beam.

13. A projection system as claimed in claim 12, wherein said recombination prism (44) is adapted to receive encoded red, green and blue light from said first (36a), second (36b) and third (36c) transmissive display panel units, and said recombination prism (44) recombining said encoded red, green and blue light into a single encoded light beam to be projected through a projection lens (46) onto said projection surface (12).

14. A projection system as claimed in claim 11, further comprising focusing lenses (52a, 52b, 52c and 54a) for focusing said encoded light before said colour recombination prism (44).

15. A projection system as claimed in claim 1, further comprising magnifying lenses (26, 34) for providing a polarized light beam covering the full surface of said transmissive display panel (36).
